(19) United States
(12) Patent Application Publication
(10) Pub. No.: US 2024/0310249 A1
(43) Pub. Date: Sep. 19, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Ryusei KAWABATA, Kanagawa (JP); Masayoshi MIKI, Kanagawa (JP)

(73) Assignee: FUJIFILM Business Innovation Corp., Tokyo (JP)

(21) Appl. No.: 18/453,337

(22) Filed: Aug. 22, 2023

(30) Foreign Application Priority Data
Mar. 17, 2023 (JP) 2023-042928

(51) Int. Cl. G01M 99/00

(52) U.S. Cl. CPC G01M 99/005

(57) ABSTRACT

An information processing system includes a processor configured to: collect sound information about sounds occurring in a monitored apparatus; store collected sound information together with characteristic information about the collected sound information; store, when collected sound information is transmitted to a set external apparatus, characteristic information pertaining to the sound information transmitted to the external apparatus; and select and transmit to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.

### CROSS-REFERENCE TO RELATED APPLICATIONS

This application is based on and claims priority under 35 USC 119 from Japanese Patent Application No. 2023-042928 filed Mar. 17, 2023.

### BACKGROUND

### (i) Technical Field

The present disclosure relates to an information processing system, an information processing method, and a non-transitory computer readable medium.

### (ii) Related Art

Japanese Patent No. 6840971 discloses a diagnosis device that determines that acquired sound information contains abnormal sounds if the total area of periodically occurring frequency components is equal to or greater than a preset value.

Japanese Unexamined Patent Application Publication No. 2007-265210 discloses a trouble diagnosis system that collects and records the operating sounds of an HDD with a microphone, compares the recorded sound data to normal operating sounds, and transmits the sound data to a server if the recorded sounds are determined to be dissimilar to normal operating sounds.

Japanese Unexamined Patent Application Publication No. 2019-116007 discloses a trouble diagnosis system that stores the driving sounds of components in a trouble-free state as normal sounds and identifies a malfunctioning component by the difference between the normal sounds and strange or unusual sounds collected when an abnormality is detected.

### SUMMARY

A system has been proposed to collect sound information occurring in an apparatus such as an image forming apparatus installed in an office and transmit the collected sound information to a server or the like. However, sound information is typically of a larger data size compared to text information or the like, and thus there is a possibility that the frequent transmission of sound information to the server may create congestion on a communication channel. For this reason, a method is used in which only the sound information with the highest abnormal sound level is transmitted from the image forming apparatus to the server at a preset frequency of approximately once per day, for example. However, when such a method is employed, even if there are multiple causes of abnormal sounds and multiple abnormal sounds with different causes are occurring, only the sound information with the highest abnormal sound level is transmitted, and the sound information with the second-highest and lower abnormal sound levels is not transmitted to the server.

Aspects of non-limiting embodiments of the present disclosure relate to providing an information processing system and a program in which, when sound information collected in a monitored apparatus is transmitted to a set destination, it is possible to avoid a situation where the same sound information is transmitted repeatedly when multiple abnormal sounds with different causes are occurring in the monitored apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: collect sound information about sounds occurring in a monitored apparatus; store collected sound information together with characteristic information about the collected sound information; store, when collected sound information is transmitted to a set external apparatus, characteristic information pertaining to the sound information transmitted to the external apparatus; and select and transmit to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.

### BRIEF DESCRIPTION OF THE DRAWINGS

An exemplary embodiment of the present disclosure will be described in detail based on the following figures, wherein:

FIG. 1 is a diagram illustrating a configuration of an information processing system according to an exemplary embodiment of the present disclosure;

FIG. 2 is a block diagram illustrating a hardware configuration of an image forming apparatus 10 according to an exemplary embodiment of the present disclosure;

FIG. 3 is a block diagram illustrating a functional configuration of the image forming apparatus 10 according to an exemplary embodiment of the present disclosure;

FIG. 4 is a diagram illustrating an example of sound information collected by an operating sound collection unit 34;

FIG. 5 is a diagram illustrating an example of abnormal sound detection when periodic abnormal sounds occur;

FIG. 6 is a diagram illustrating an example of abnormal sound detection when continuous abnormal sounds occur;

FIG. 7 is a diagram illustrating an example of abnormal sound detection when sudden abnormal sounds occur;

FIG. 8 is a diagram illustrating an example of an abnormal sound information retention table in the case of retaining only one piece of abnormal sound information with the highest abnormal sound level;

FIG. 9 is a flowchart for describing operations by the image forming apparatus 10 during abnormal sound collection in the case of retaining only one piece of abnormal sound information with the highest abnormal sound level;

FIG. 10 is a flowchart for describing operations by the image forming apparatus 10 during server transmission in the case of retaining only one piece of abnormal sound information with the highest abnormal sound level;

FIG. 11 is a diagram illustrating an example of an abnormal sound information retention table in the case of retaining three pieces of abnormal sound information with high abnormal sound levels;

FIG. 12 is a flowchart for describing operations by the image forming apparatus 10 during abnormal sound collection in the case of retaining three pieces of abnormal sound information with high abnormal sound levels;

FIG. 13 is a flowchart for describing operations by the image forming apparatus 10 during server transmission in the case of retaining three pieces of abnormal sound information with high abnormal sound levels;

FIG. 14 is a diagram illustrating an example of an abnormal sound information retention table in the case of retaining three pieces of abnormal sound information with high abnormal sound levels together with an abnormal sound type;

FIG. 15 is a flowchart for describing operations by the image forming apparatus 10 during abnormal sound collection in the case of retaining three pieces of abnormal sound information with high abnormal sound levels together with an abnormal sound type;

FIG. 16 is a flowchart for describing operations by the image forming apparatus 10 during server transmission in the case of retaining three pieces of abnormal sound information with high abnormal sound levels together with an abnormal sound type;

FIG. 17 is a diagram for describing a specific example of a process for not consecutively transmitting abnormal sound information of the same abnormal sound type as abnormal sound information transmitted at the previous transmission time of abnormal sound information;

FIG. 18 is a diagram illustrating an example of an abnormal sound information retention table in the case of using paper tray information used as characteristic information; and

FIG. 19 is a diagram illustrating an example of an abnormal sound information retention table in the case of retaining abnormal sound information with high abnormal sound levels together with detailed device information.

### DETAILED DESCRIPTION

Next, an exemplary embodiment of the present disclosure will be described in detail and with reference to the drawings.

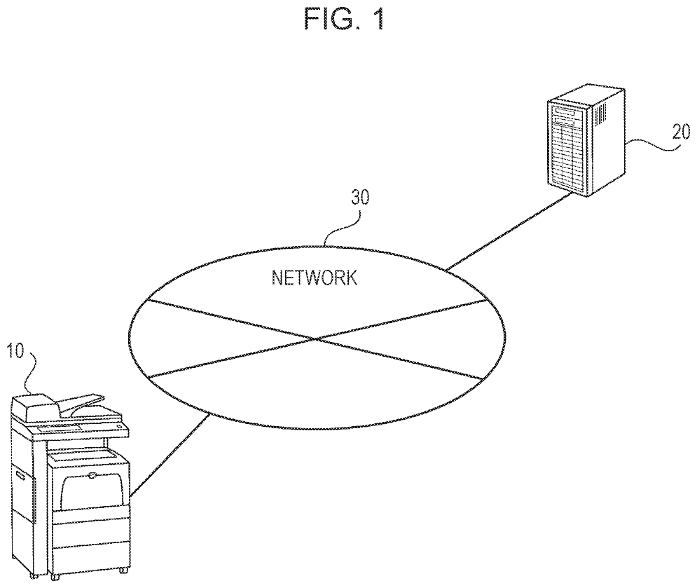

FIG. 1 is a diagram illustrating a configuration of an information processing system according to an exemplary embodiment of the present disclosure.

As illustrated in FIG. 1, the information processing system according to an exemplary embodiment of the present disclosure includes an image forming apparatus 10 and a management server 20 interconnected through a network 30 such as the Internet. The image forming apparatus 10 is an apparatus referred to as a multi-function device, and includes multiple functions such as a print function, a scan function, a copy function, and a facsimile function.

The image forming apparatus 10 is installed and used in any of various locations, such as an office or a store, for example. If trouble of some kind occurs in the image forming apparatus 10, a maintenance worker referred to as a customer engineer (CE) goes to the location where the image forming apparatus 10 is installed to make repairs. For this reason, even if trouble of some kind is occurring in the image forming apparatus 10, maintenance work would be facilitated if certain information could be obtained in advance, such as what kind of trouble is occurring and which components are to be replaced.

Accordingly, the image forming apparatus 10 according to the exemplary embodiment collects as sound information the operating sounds that occur when various jobs, such as a print job and a copy job, are executed, and if the collected sound information contains strange or unusual sounds (hereinafter simply referred to as abnormal sounds), transmits the collected sound information to the management server 20 as abnormal sound information.

By transmitting abnormal sound information to the management server 20 in this way, the transmitted abnormal sound information may be analyzed to estimate the case of the trouble and various measures may be taken, such as the preparation of replacement components and a preliminary survey of repair methods.

However, sound information is typically of a larger data size compared to text information or the like, and thus there is a possibility that the frequent transmission of sound information from the image forming apparatus 10 to the management server 20 may create congestion on a communication channel. For this reason, a method is used in which only the sound information with the highest abnormal sound level is transmitted from the image forming apparatus 10 to the management server 20 at a preset frequency of approximately once per day, for example.

As an example, the following description assumes that 0:00 is set as the transmission time of abnormal sound information and that one piece of abnormal sound data is set to be transmitted from the image forming apparatus 10 to the management server 20 when this transmission time of abnormal sound information is reached every day. Note that the transmission time of abnormal sound information, the transmission frequency of abnormal sound information, the number of pieces of abnormal sound data to be transmitted, and the like are not limited to the above.

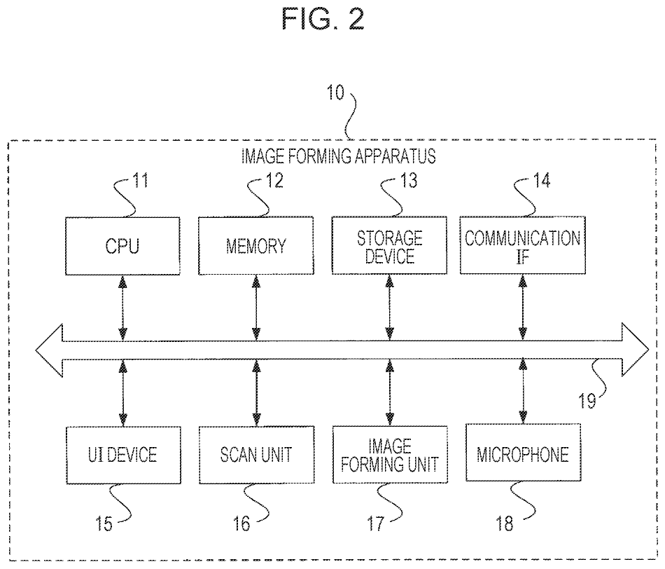

Next, a hardware configuration of the image forming apparatus 10 in an image forming system according to the exemplary embodiment is illustrated in FIG. 2.

As illustrated in FIG. 2, the image forming apparatus 10 includes a CPU 11, a memory 12, a storage device 13 such as a hard disk drive, a communication interface (abbreviated to IF) 14 that transmits and receives data to and from an external apparatus or the like over the network 30, a user interface (abbreviated to UI) device 15 including a touch panel or a liquid crystal display and a keyboard, a scan unit 16, an image forming unit 17, and a microphone 18. These components are interconnected through a control bus 19.

The image forming unit 17 prints an image onto a recording medium such as printing paper via steps such as charging, exposing, developing, transferring, and fusing.

The CPU 11 is a processor that controls operations by the image forming apparatus 10 by executing predetermined processes on the basis of a control program stored in the memory 12 or the storage device 13. Note that although the CPU 11 is described as reading out and executing a control program stored in the memory 12 or the storage device 13 in the exemplary embodiment, the control program is not limited thereto. The control program may also be provided by being recorded onto a computer-readable recording medium. For example, the program may be provided by being recorded on an optical disc, such as a Compact Disc Read-Only Memory (CD-ROM) or a Digital Versatile Disc Read-Only Memory (DVD-ROM), or by being recorded on a semiconductor memory, such as Universal Serial Bus (USB) memory or a memory card. The control program may also be acquired from an external apparatus over a communication channel connected to the communication interface 14.

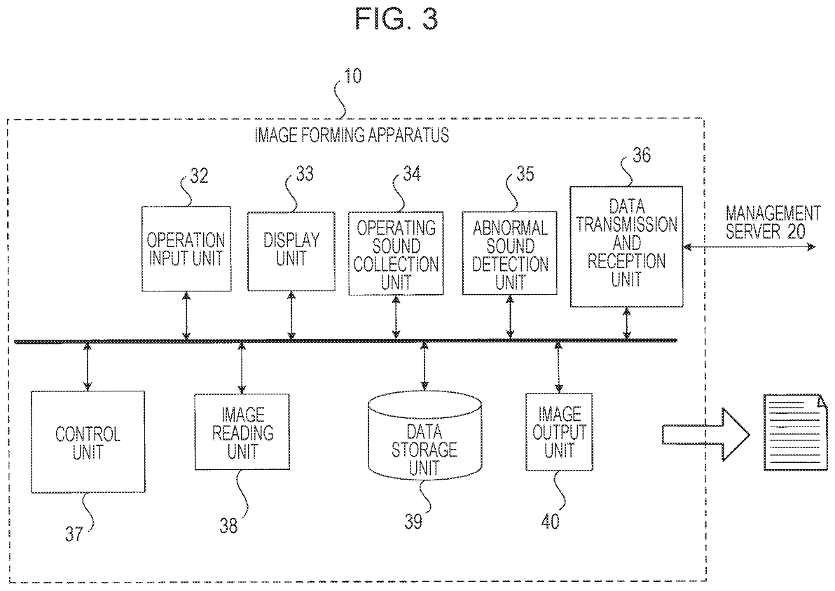

FIG. 3 is a block diagram illustrating a functional configuration of the image forming apparatus 10 achieved through the execution of the above control program.

As illustrated in FIG. 3, the image forming apparatus 10 according to the exemplary embodiment is provided with an operation input unit 32, a display unit 33, an operating sound collection unit 34, an abnormal sound detection unit 35, a data transmission and reception unit 36, a control unit 37, an image reading unit 38, a data storage unit 39, and an image output unit 40.

The operation input unit 32 inputs information on various operations performed by a user. The display unit 33 is controlled by the control unit 37 to display various information to the user. The data transmission and reception unit 36 transmits and receives data to and from an external apparatus such as the management server 20.

The control unit 37 controls the image reading unit 38 and the image output unit 40 on the basis of a user instruction inputted by the operation input unit 32 or the like, and executes various jobs, such as a print job and a copy job. The data storage unit 39 stores various data such as print data generated by the control unit 37.

The image output unit 40, under control by the control unit 37, outputs an image onto a recording medium such as printing paper. The image reading unit 38, under control by the control unit 37, reads an original document image from an original document placed therein or thereon.

The operating sound collection unit 34 collects sound information about sounds such as operating sounds occurring in the monitored apparatus, that is, the image forming apparatus 10. Specifically, the operating sound collection unit 34 records the operating sounds when the image forming apparatus 10 executes a print job or the like and collects the operating sounds as the data of sound information.

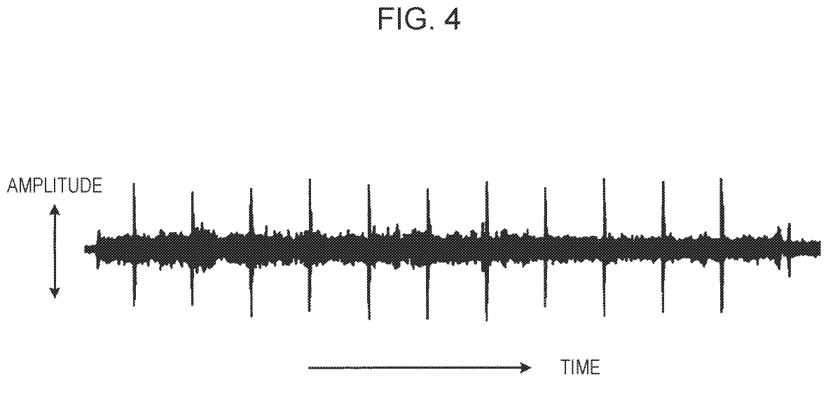

An example of sound information collected by the operating sound collection unit 34 is illustrated in FIG. 4. In the sound information illustrated in FIG. 4, the vertical axis is amplitude and the horizontal axis is time. In other words, the sound information illustrated in FIG. 4 is an illustration of the change in amplitude over time.

The control unit 37 stores the sound information collected by the operating sound collection unit 34, together with characteristic information about the sound information, in the data storage unit 39.

In the data storage unit 39 according to the exemplary embodiment, sound information when various components and the like are operating normally without abnormality is stored as normal sound information. The abnormal sound detection unit 35 compares the sound information collected by the operating sound collection unit 34 to the normal sound information to determine whether the collected sound information contains abnormal sounds.

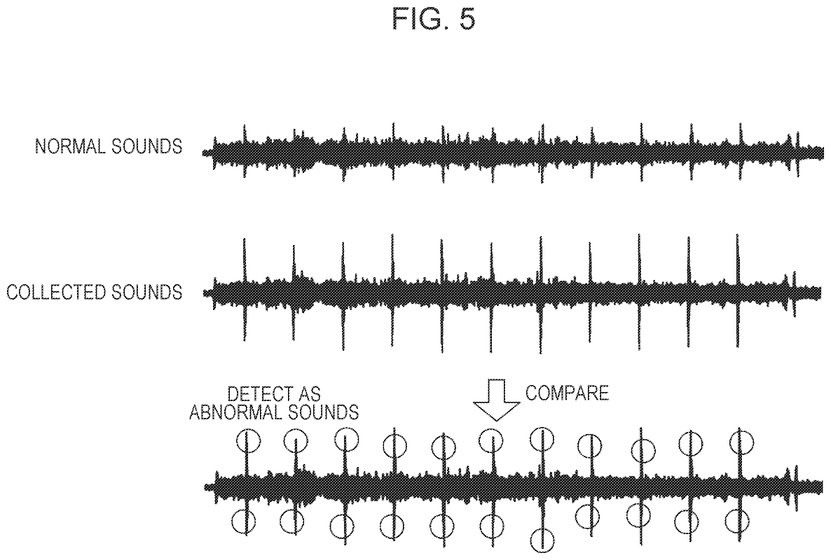

Specific examples of abnormal sound detection by the abnormal sound detection unit 35 are illustrated in FIGS. 5 to 7.

First, an example of abnormal sound detection when periodic abnormal sounds occur is illustrated in FIG. 5. Referring to FIG. 5, the diagram illustrates how the abnormal sound detection unit 35 compares the normal sounds stored in advance and the collected sounds and extracts the differences to detect periodic abnormal sound portions. By having the abnormal sound detection unit 35 detect which portions of the collected sound information are abnormal sound portions in this way, in FIG. 5, the abnormal sounds contained in the collected sound information may be detected as periodic abnormal sounds.

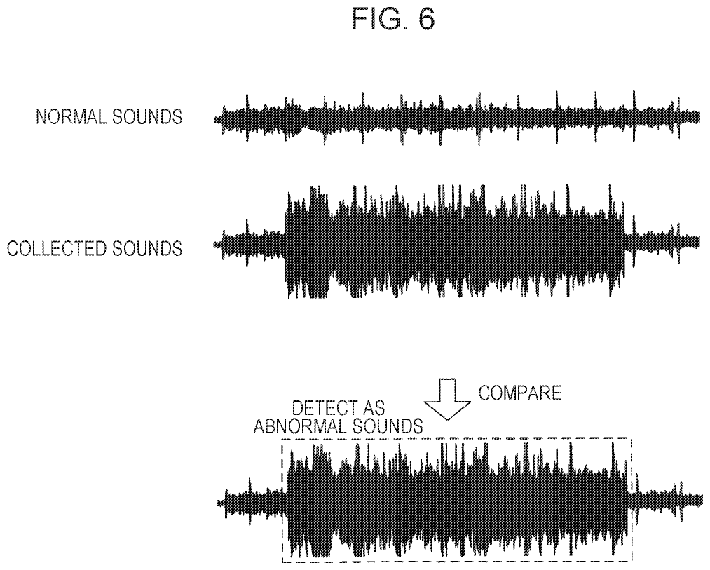

Also, an example of abnormal sound detection when continuous abnormal sounds occur is illustrated in FIG. 6. Referring to FIG. 6, the diagram illustrates how the abnormal sound detection unit 35 compares the normal sounds stored in advance and the collected sounds and extracts the differences to detect a continuous abnormal sound portion.

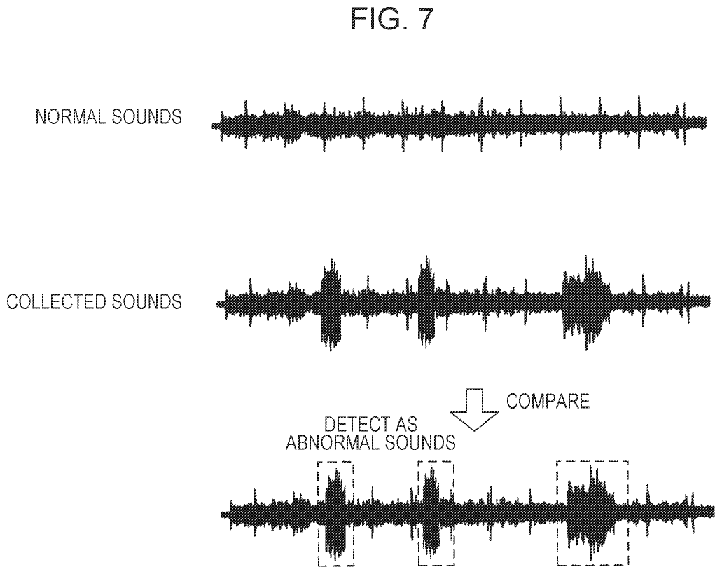

Furthermore, an example of abnormal sound detection when sudden abnormal sounds occur is illustrated in FIG. 7. Referring to FIG. 7, the diagram illustrates how the abnormal sound detection unit 35 compares the normal sounds stored in advance and the collected sounds and extracts the differences to detect sudden abnormal sound portions.

The control unit 37 stores only the sound information determined to contain abnormal sounds by the abnormal sound detection unit 35, together with characteristic information about the sound information, in the data storage unit 39.

Additionally, when the sound information collected by the operating sound collection unit 34 is transmitted to a set external apparatus, that is, the management server 20, the control unit 37 stores the characteristic information pertaining to the sound information transmitted to the management server 20 in the data storage unit 39. Thereafter, when a piece of sound information is selected from among the sound information stored in the data storage unit 39 and is to be transmitted to the management server 20, the control unit 37 selects and transmits to the management server 20 another piece of sound information, without selecting sound information having the same characteristic information as the characteristic information of the sound information that was transmitted to the management server 20 within a preset period in the past.

Characteristic information about sound information is, for example, information on the type of abnormal sounds contained in the sound information. The types of abnormal sounds contained in sound information specifically include at least two from among sudden abnormal sounds, periodically occurring abnormal sounds, and continuous (or steady) abnormal sounds.

Furthermore, characteristic information about sound information may be, for example, information pertaining to details of operations by the monitored apparatus, that is, the image forming apparatus 10, when the sound information is collected. Information pertaining to details of operations by the image forming apparatus 10 when the sound information is collected includes at least two pieces of information from among information on the type of device that is operating when the sound information is collected, information on components used, and information pertaining to the operating state.

The information on the type of device that is operating when the sound information is collected specifically is information indicating, among other things, whether the image output unit 40 is operating, whether the image reading unit 38 is operating, or which paper tray from among multiple paper trays is operating when the sound information is collected.

Also, the information on components used specifically is information indicating which components are in use when the operating sounds are collected. Furthermore, in the case in which the job executed when the operating sounds are collected is a print job, the information pertaining to the operating state is information that allows the operating state to be ascertained, such as information indicating whether double-sided printing or single-sided printing was being performed and information indicating whether color printing or black and white printing was being performed.

Note that although the exemplary embodiment describes a case in which the abnormal sound detection unit 35 is provided in the image forming apparatus 10, the abnormal sound detection unit 35 may also not be provided in the image forming apparatus 10 and determine on the management server 20 side whether operating sounds or other sound information contains abnormal sounds. Even in the case in which the abnormal sound detection unit 35 is not provided in the image forming apparatus 10 in this way, if information pertaining to abnormal sound type is stored as characteristic information together with collected sound information, the function of determining the abnormal sound type of the sound information collected by the operating sound collection unit 34 is provided in the image forming apparatus 10.

Note that even if multiple pieces of sound information collected by the operating sound collection unit 34 are stored in the data storage unit 39, the control unit 37 stores only the sound information with the highest sound level among the collected sound information with the same characteristic information.

Next, operations in the image forming apparatus 10 according to the exemplary embodiment will be described in detail with reference to the drawings.

[Case of Retaining Only One Piece of Abnormal Sound Information with Highest Abnormal Sound Level]

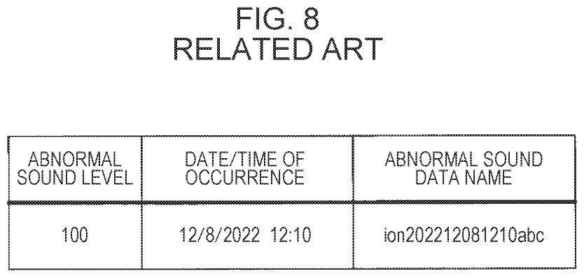

First, before describing operations by the image forming apparatus 10 according to the exemplary embodiment, operations in the case of retaining only one piece of abnormal sound information with the highest abnormal sound level will be described as a reference example with reference to FIGS. 8 to 10.

An example of an abnormal sound information retention table in the case of retaining only one piece of abnormal sound information with the highest abnormal sound level is illustrated in FIG. 8.

The abnormal sound information retention table is a list of abnormal sound data stored in the data storage unit 39. In the abnormal sound information retention table illustrated in FIG. 8, only one piece of abnormal sound information is registered, in which an abnormal sound level, a date and time of occurrence, and an abnormal sound name pertaining to the abnormal sound information are associated. The abnormal sound level is an indicator of which a larger value indicates a louder sound. Any of various values indicating the loudness of sound, such as the amplitude value of the acquired abnormal sound data or the acquired sound pressure level [dB], is usable as the indicator of the abnormal sound level.

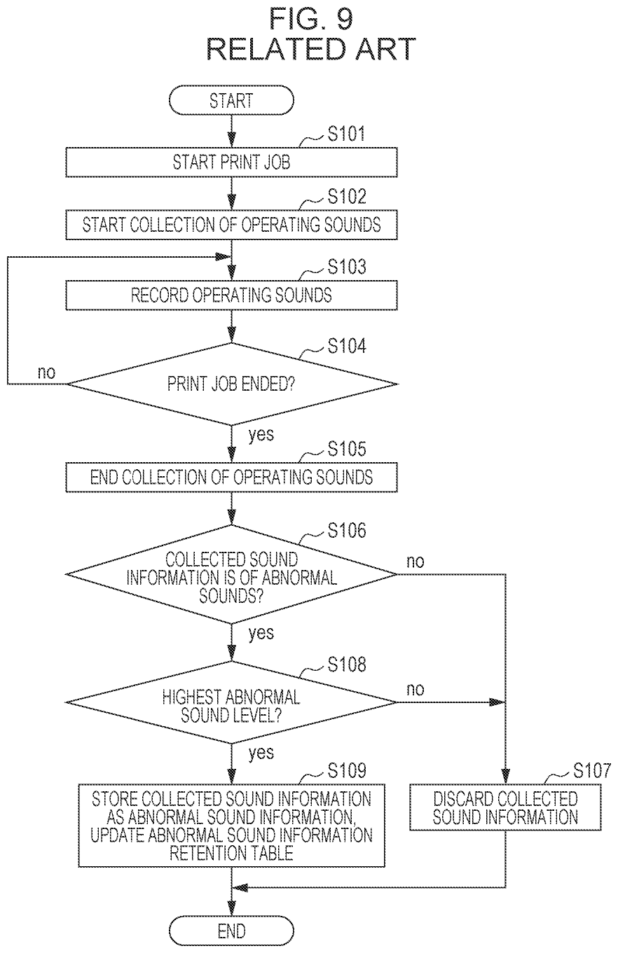

Next, operations during abnormal sound collection in the case of retaining only one piece of abnormal sound information with the highest abnormal sound level will be described, as applied to the image forming apparatus 10 according to the exemplary embodiment. The operations in this case are illustrated in the flowchart in FIG. 9.

The flowchart in FIG. 9 is for describing the case of executing a print job, but the same also applies to the case of executing another job, such as a scan job or a copy job.

First, in step S101, when the print job is started, in step S102, the control unit 37 controls the operating sound collection unit 34 to start the collection of operating sounds. Accordingly, in step S103, operating sounds are recorded while the print job is executed.

In step S104, if it is determined that the print job has ended, in step S105, the control unit 37 controls the operating sound collection unit 34 to end the collection of operating sounds. Accordingly, the recording of operating sounds in step S103 continues until it is determined in step S104 that the print job has ended.

Next, in step S106, the control unit 37 determines whether the collected sound information is of abnormal sounds. Specifically, the control unit 37 instructs the abnormal sound detection unit 35 to perform abnormal sound detection on the sound information collected by the operating sound collection unit 34. Thereafter, the control unit 37 refers to an abnormal sound detection result from the abnormal sound detection unit 35 and determines whether the collected sound information is of abnormal sounds or normal sounds.

In step S106, if it is determined that the collected sound information is not of abnormal sounds, in step S107, the control unit 37 discards the collected sound information and ends the process.

In step S106, if it is determined that the collected sound information is of abnormal sounds, the control unit 37 determines that the sound information is abnormal sound information, and in step S108, determines whether the abnormal sound level of the abnormal sound information is the highest. At this point, determining whether the abnormal sound level of the abnormal sound information is the highest specifically means determining whether the abnormal sound level of the collected abnormal sound information is higher than the abnormal sound level of the abnormal sound information retained in the abnormal sound information retention table illustrated in FIG. 8.

In step S108, if it is determined that the abnormal sound level of the collected sound information is not the highest, in step S107, the control unit 37 discards the collected sound information and ends the process.

Also, in step S108, if it is determined that the abnormal sound level of the collected sound information is the highest, in step S109, the control unit 37 stores the collected sound information as abnormal sound information in the data storage unit 39, updates the abnormal sound information retained in the abnormal sound information retention table, and ends the process.

By performing a process like the above, if the transmission frequency of abnormal sound information is once per day, only the abnormal sounds with the highest abnormal sound level from among the abnormal sounds occurring on that day are retained as abnormal sound information.

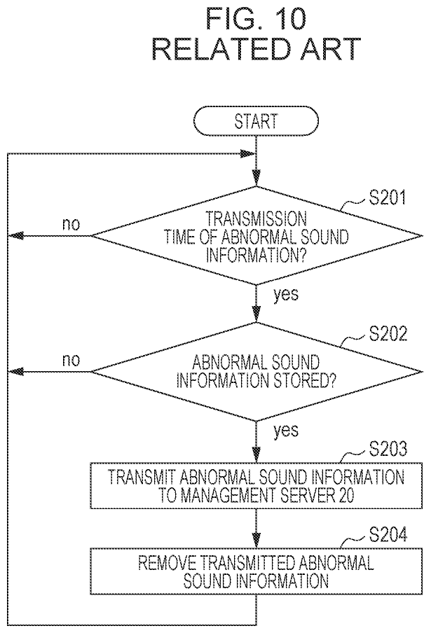

Next, operations during server transmission in the case of retaining only one piece of abnormal sound information with the highest abnormal sound level are illustrated in the flowchart in FIG. 10.

In step S201, if it is determined that the transmission time of abnormal sound information has arrived, in step S202, the control unit 37 references the abnormal sound information retention table to determine whether abnormal sound information is stored.

In step S202, if it is determined that abnormal sound information is not stored, the control unit 37 returns to the process in step S201 without transmitting the abnormal sound information.

In step S202, if it is determined that abnormal sound information is stored, in step S203, the control unit 37 reads out and transmits, to the management server 20 via the data transmission and reception unit 36, the abnormal sound data corresponding to the stored abnormal sound information.

Additionally, in step S204, the control unit 37 removes the transmitted abnormal sound information from the abnormal sound information retention table and returns to the process in step S201.

By performing a process like the above, if the transmission frequency of abnormal sound information is once per day, the abnormal sound information with the highest abnormal sound level from among the abnormal sounds occurring on that day is transmitted to the management server 20.

However, if only one piece of abnormal sound information with the highest abnormal sound level is retained in this way, but trouble occurs in two different components, there is a possibility that even though two different abnormal sounds are occurring, abnormal sound information for only the one with the higher abnormal sound level may be transmitted to the management server 20. In other words, if two abnormal sounds with different causes are occurring every day, abnormal sound information for the other with the lower abnormal sound level is neither retained in the abnormal sound information retention table nor transmitted to the management server 20.

As a result, even if the abnormal sound information transmitted to the management server 20 is analyzed, the cause of the other abnormal sounds with the lower abnormal sound level will not be ascertained, and the maintenance worker will discover that two different types of trouble are occurring only after going to the location where the image forming apparatus 10 is installed.

[Case of Retaining Three Pieces of Abnormal Sound Information with High Abnormal Sound Levels]

Accordingly, a case will be described in which three pieces of abnormal sound information are retained in the abnormal sound information retention table, such that even if three abnormal sounds occur in a single day, not only the abnormal sound information with the highest abnormal sound level but also the second-highest and third-highest abnormal sound information are transmitted.

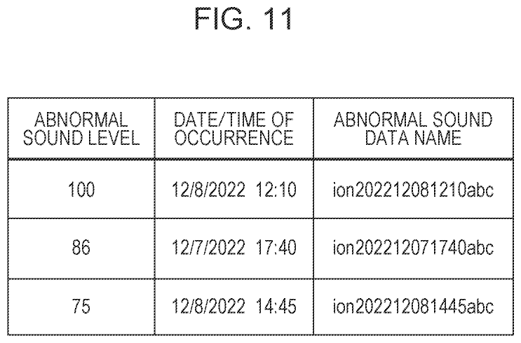

Operations by the image forming apparatus 10 in the case in which three pieces of abnormal sound information are retained in the abnormal sound information retention table will be described with reference to FIGS. 11 to 13.

An example of an abnormal sound information retention table in the case of retaining three pieces of abnormal sound information with high abnormal sound levels is illustrated in FIG. 11.

In the abnormal sound information retention table illustrated in FIG. 11, it is seen that not only abnormal sound information with an abnormal sound level of 100 but also abnormal sound information with abnormal sound levels of 86 and 75 are retained.

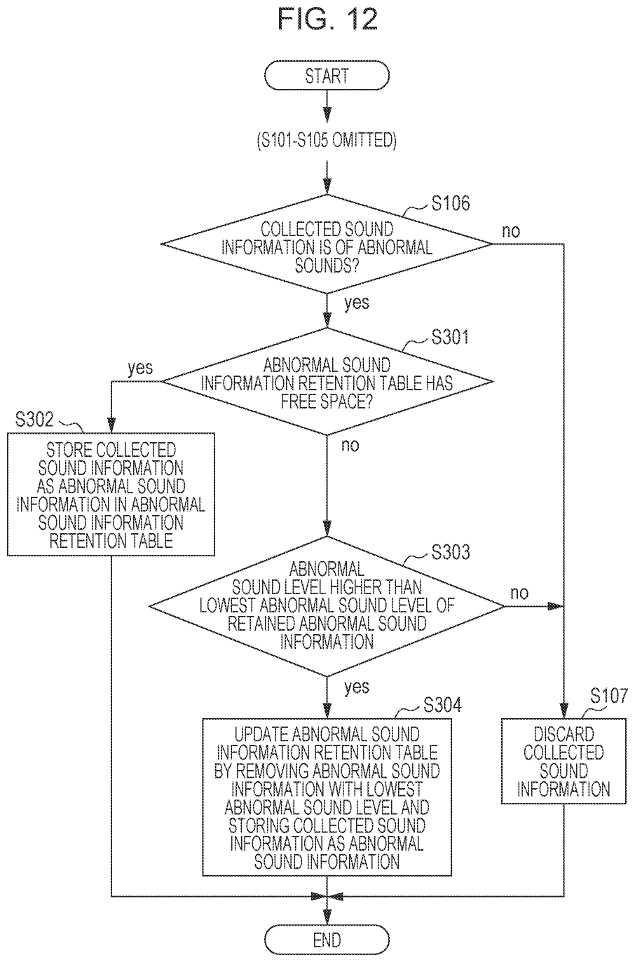

Next, operations by the image forming apparatus 10 during abnormal sound collection in the case of retaining three pieces of abnormal sound information with high abnormal sound levels will be described with reference to the flowchart in FIG. 12.

Note that in the flowchart in FIG. 12, the processes in steps S105 to S105 are the same as those in the flowchart in FIG. 9, and therefore are omitted. Also, the processes in steps S106 and S107 in the flowchart in FIG. 12 are the same as the processes in steps S106 and S107 in the flowchart in FIG. 9.

In step S106, if it is determined that the collected sound information is of abnormal sounds, the control unit 37 determines that the sound information is abnormal sound information, and in step S301, determines whether the abnormal sound information retention table has free space.

In step S301, if it is determined that the abnormal sound information retention table has free space, in step S302, the control unit 37 stores the collected sound information as abnormal sound information in the abnormal sound information retention table.

In step S301, if it is determined that the abnormal sound information retention table does not have free space, or in other words, that three pieces of abnormal sound information are already retained, in step S303, the control unit 37 determines whether the abnormal sound level of the collected abnormal sound information is higher than the lowest abnormal sound level of the three pieces of abnormal sound information being retained.

In step S303, if it is determined that the abnormal sound level of the collected abnormal sound information is lower than the lowest abnormal sound level of the three pieces of abnormal sound information being retained, in step S107, the control unit 37 discards the collected sound information and ends the process.

In step S303, if it is determined that the abnormal sound level of the collected abnormal sound information is higher than the lowest abnormal sound level of the three pieces of abnormal sound information being retained, in step S304, the control unit 37 updates the abnormal sound information retention table by removing the abnormal sound information with the lowest abnormal sound level from the abnormal sound information retention table and storing the collected sound information as abnormal sound information.

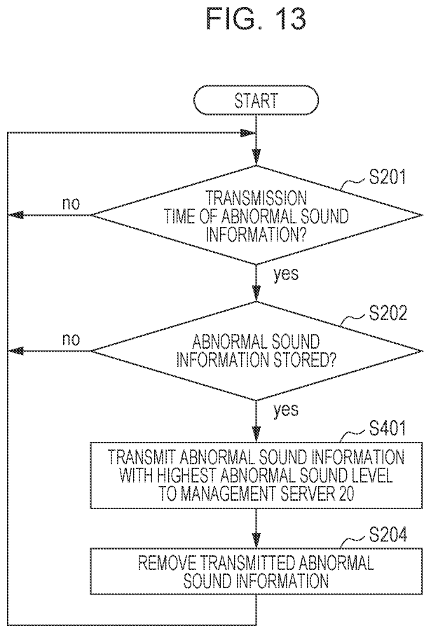

Next, operations during server transmission in the case of retaining three pieces of abnormal sound information with high abnormal sound levels are illustrated in the flowchart in FIG. 13.

Note that the processes in steps S201, S202, and S204 in the flowchart in FIG. 13 are the same as the processes in steps S201, S202, and S204 in the flowchart in FIG. 10, and therefore a description is omitted.

In step S202, if it is determined that abnormal sound information is stored, in step S401, the control unit 37 reads out and transmits, to the management server 20 via the data transmission and reception unit 36, the abnormal sound data corresponding to the abnormal sound information with the highest abnormal sound level among the stored abnormal sound information.

Additionally, in step S204, the control unit 37 removes the transmitted abnormal sound information from the abnormal sound information retention table and returns to the process in step S201.

By performing a process like the above, if the transmission frequency of abnormal sound information is once per day and two or more pieces of abnormal sound information are collected on a certain day, the abnormal sound information with the second-highest abnormal sound level will be transmitted to the management server 20 at the transmission time of abnormal sound information on the following day, insofar as abnormal sound information exceeding the abnormal sound level of the abnormal sound information with the second-highest abnormal sound level is not collected on the following day.

However, even if three pieces of abnormal sound information are retained in the abnormal sound information retention table in this way, if abnormal sound information having around the same abnormal sound level as the abnormal sound information transmitted to the management server 20 on the previous day is also collected on the following day, the same information will be transmitted as abnormal sound information to the management server 20 every day. Here, the same sound information does not mean only the case in which two pieces of sound information match perfectly, but means sound information with the same abnormal sound type or other attributes, as with abnormal sound information occurring due to the same cause or from the same place.

[Case of Retaining Three Pieces of Abnormal Sound Information with High Abnormal Sound Levels Together with Abnormal Sound Type]

Accordingly, in the image forming apparatus 10 according to the exemplary embodiment, multiple pieces of abnormal sound information with high abnormal sound levels are retained together with an abnormal sound type of the abnormal sound information in the abnormal sound information retention table.

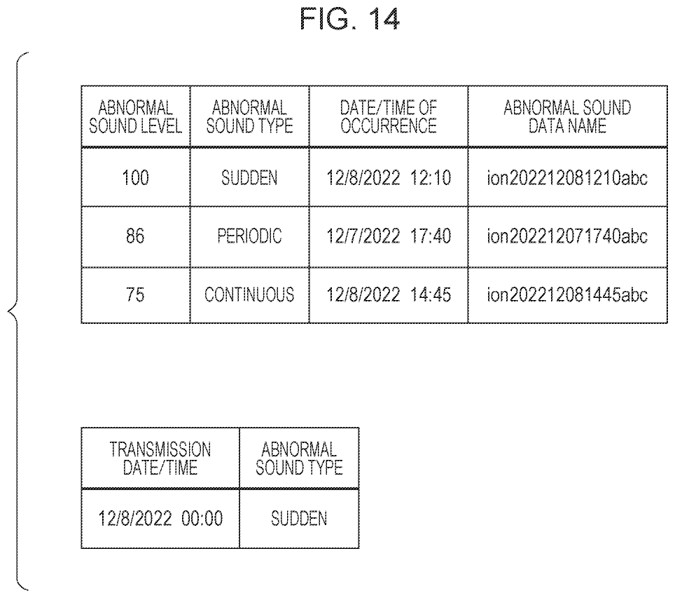

Operations by the image forming apparatus 10 in the case of retaining three pieces of abnormal sound information with high abnormal sound levels together with the abnormal sound type in the abnormal sound information retention table will be described with reference to FIGS. 14 to 17.

An example of an abnormal sound information retention table in the case of retaining three pieces of abnormal sound information with high abnormal sound levels together with the abnormal sound type is illustrated in FIG. 14.

In the abnormal sound information retention table illustrated in FIG. 14, it is seen that three pieces of abnormal sound information with abnormal sound levels of 100, 86, and 75 are retained together with information on the abnormal sound type of each piece of abnormal sound information. Specifically, the abnormal sound information with the abnormal sound level of 100 is of the “sudden” abnormal sound type, the abnormal sound information with the abnormal sound level of 86 is of the “periodic” abnormal sound type, and the abnormal sound information with the abnormal sound level of 75 is of the “continuous” abnormal sound type.

Additionally, in the exemplary embodiment, information on the abnormal sound type of the abnormal sound information transmitted to the management server 20 at the previous abnormal sound transmission time is stored in the data storage unit 39 as an abnormal sound information transmission history table, separately from the abnormal sound information retention table. By referring to the abnormal sound information transmission history table, it is seen that the abnormal sound information transmitted to the management server 20 at the previous abnormal sound transmission time of “12/8/2022 00:00” was of the “sudden” abnormal sound type.

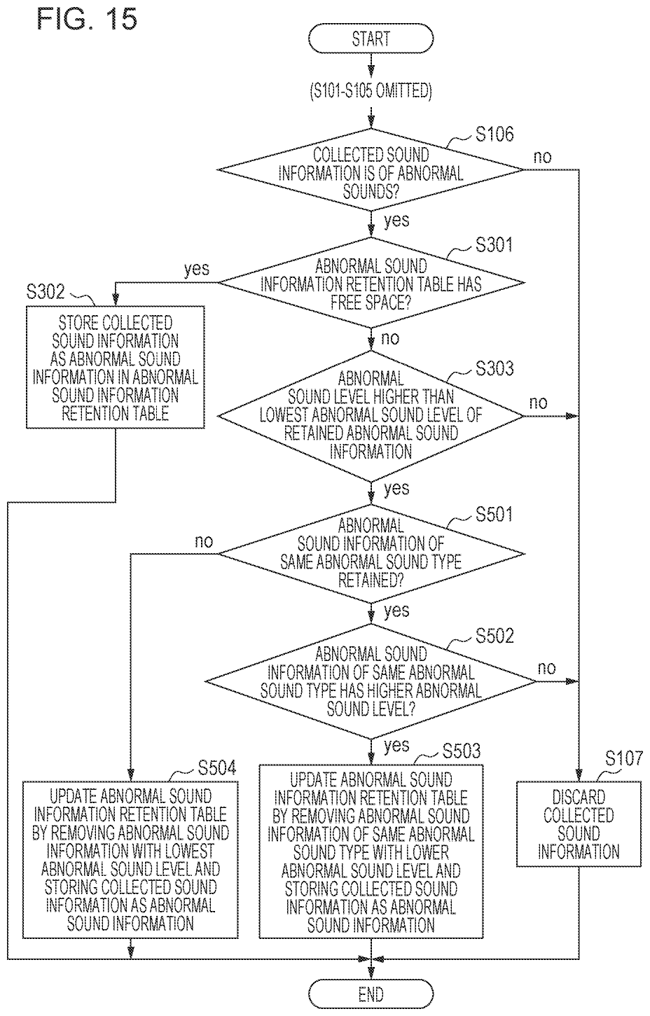

Next, operations by the image forming apparatus 10 during abnormal sound collection in the case of retaining three pieces of abnormal sound information with high abnormal sound levels together with the abnormal sound type will be described with reference to the flowchart in FIG. 15.

Note that in the flowchart in FIG. 15, the processes in steps S105 to S105 are the same as those in the flowchart in FIG. 9, and therefore are omitted. Also, the processes in steps S106 and S107 in the flowchart in FIG. 15 are the same as the processes in steps S106 and S107 in the flowchart in FIG. 9. Furthermore, the processes in steps S301 to S303 in the flowchart in FIG. 15 are the same as the processes in steps S301 to S303 in the flowchart in FIG. 12.

In step S303, if it is determined that the abnormal sound level of the collected abnormal sound information is higher than the lowest abnormal sound level of the three pieces of abnormal sound information being retained, in step S501, the control unit 37 determines whether abnormal sound information of the same abnormal sound type as the abnormal sound type of the currently collected abnormal sound information is retained.

In step S501, if it is determined that abnormal sound information of the same abnormal sound type as the abnormal sound type of the currently collected abnormal sound information is retained, in step S502, the control unit 37 determines whether the abnormal sound level of the currently collected abnormal sound information is higher than the abnormal sound level of the abnormal sound information of the same abnormal sound type.

In step S502, if it is determined that the abnormal sound level of the currently collected abnormal sound information is not higher than the abnormal sound level of the abnormal sound information of the same abnormal sound type, in step S107, the control unit 37 discards the collected sound information and ends the process.

In step S502, if it is determined that the abnormal sound level of the currently collected abnormal sound information is higher than the abnormal sound level of the abnormal sound information of the same abnormal sound type, in step S503, the control unit 37 updates the abnormal sound information retention table by removing the abnormal sound information of the same abnormal sound type with the lower abnormal sound level and storing the currently collected sound information as abnormal sound information. That is, for pieces of abnormal sound information of the same abnormal sound type, the control unit 37 keeps the one with the higher abnormal sound level and removes the one with the lower abnormal sound level.

In step S501, if it is determined that abnormal sound level of the same abnormal sound type as the abnormal sound type of the currently collected abnormal sound information is not retained, in step S504, the control unit 37 updates the abnormal sound information retention table by removing the abnormal sound information with the lowest abnormal sound level from the abnormal sound information retention table and storing the collected sound information as abnormal sound information.

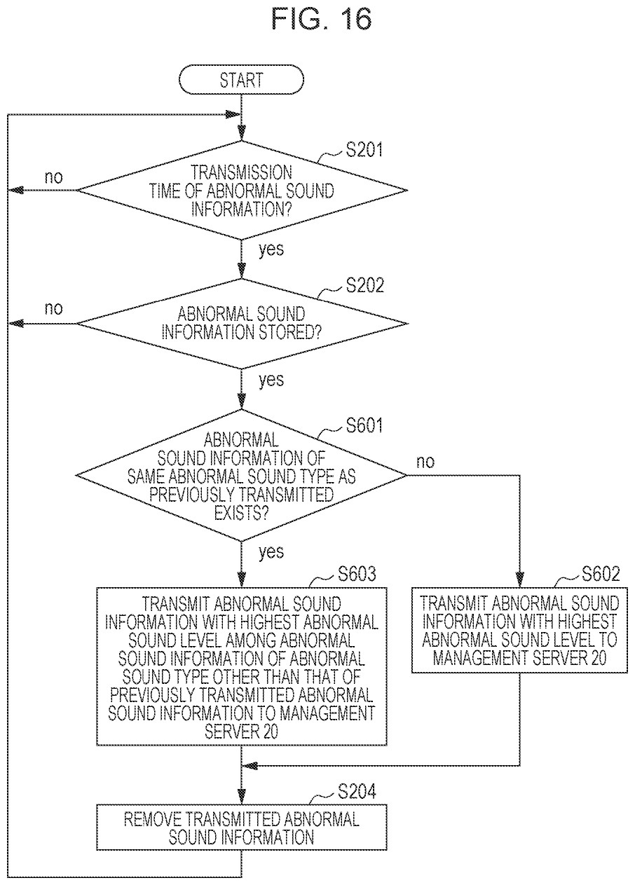

Next, operations during server transmission in the case of retaining three pieces of abnormal sound information with high abnormal sound levels together with the abnormal sound type are illustrated in the flowchart in FIG. 16.

Note that the processes in steps S201, S202, and S204 in the flowchart in FIG. 16 are the same as the processes in steps S201, S202, and S204 in the flowchart in FIG. 10, and therefore a description is omitted.

In step S202, if it is determined that abnormal sound information is stored, in step S601, the control unit 37 determines whether abnormal sound information of the same abnormal sound type as the previously transmitted abnormal sound type is retained in the abnormal sound information retention table.

In step S601, if it is determined that abnormal sound information of the same abnormal sound type as the previously transmitted abnormal sound type is not retained, in step S602, the control unit 37 reads out and transmits, to the management server 20 via the data transmission and reception unit 36, the abnormal sound data corresponding to the abnormal sound information with the highest abnormal sound level among the stored abnormal sound information.

Additionally, in step S204, the control unit 37 removes the transmitted abnormal sound information from the abnormal sound information retention table and returns to the process in step S201.

Additionally, in step S601, if it is determined that abnormal sound information of the same abnormal sound type as the previously transmitted abnormal sound type is retained, in step S603, the control unit 37 reads out and transmits, to the management server 20 via the data transmission and reception unit 36, the abnormal sound data corresponding to the abnormal sound information with the highest abnormal sound level among the abnormal sound information of an abnormal sound type other than that of the previously transmitted abnormal sound information.

Additionally, in step S204, the control unit 37 removes the transmitted abnormal sound information from the abnormal sound information retention table and returns to the process in step S201.

By performing a process like the above, abnormal sound information of the same abnormal sound type as abnormal sound information transmitted at the previous transmission time of abnormal sound information is not transmitted consecutively at the next transmission time of abnormal sound information.

That is, when a piece of abnormal sound information is selected from among the stored abnormal sound information and is to be transmitted to the management server 20, another piece of abnormal sound information is selected and transmitted to the management server 20, without selecting abnormal sound information of the same abnormal sound type as the abnormal sound type of the abnormal sound information that was transmitted to the management server 20 within a preset period in the past, specifically within the past one day.

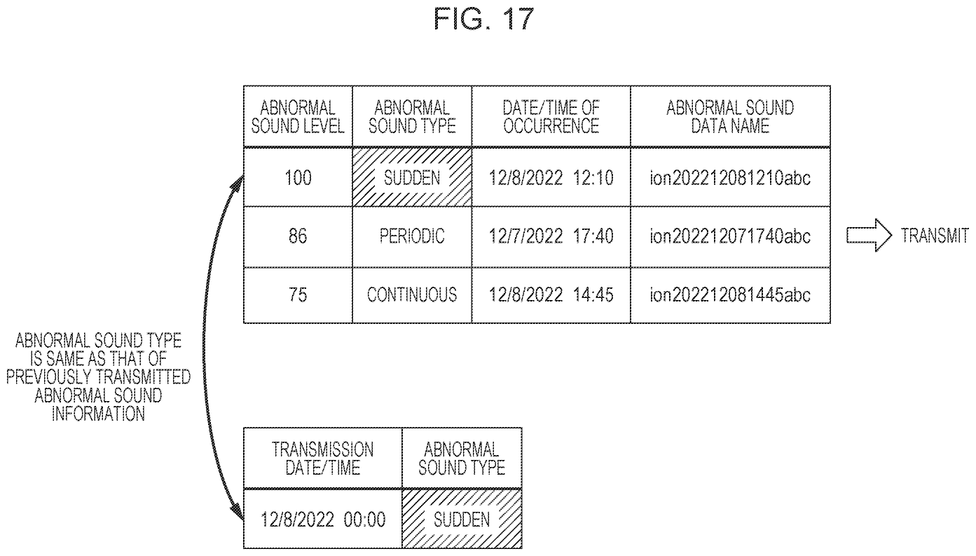

A specific example of such a process will be described with reference to FIG. 17. Referring to FIG. 17, since the abnormal sound type was “sudden” when abnormal sound information was transmitted previously, the control unit 37, when selecting the current abnormal sound information to be transmitted to the management server 20, does not select for transmission the abnormal sound information of the “sudden” abnormal sound type with an abnormal sound level of 100.

As a result, the control unit 37 selects and transmits, to the management server 20, the abnormal sound information of the “periodic” abnormal sound type with an abnormal sound level of 86. That is, when a selection is made according to the abnormal sound level only, the abnormal sound information of the “sudden” abnormal sound type with the highest abnormal sound level of 100 is selected and transmitted to the management server 20, but by excluding from selection the abnormal sound information of the same abnormal sound type as the previously transmitted abnormal sound information, the consecutive transmission of abnormal sound information of the same abnormal sound type is avoided.

Note that although the above description describes the case of using information on abnormal sound type as the characteristic information about the abnormal sound information, various information may be used as the characteristic information about the abnormal sound information.

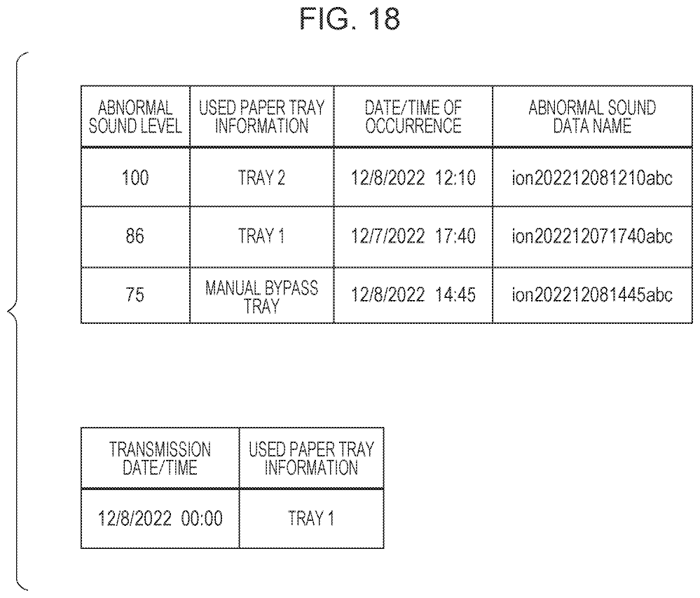

For instance, an example of an abnormal sound information retention table in the case of using paper tray information used as characteristic information is illustrated in FIG. 18. Referring to FIG. 18, it is seen that three pieces of abnormal sound information with abnormal sound levels of 100, 86, and 75 are retained together with information on the paper tray used when each piece of abnormal sound information was collected. Specifically, for the abnormal sound information with an abnormal sound level of 100, the used paper tray information is “tray 2”, for the abnormal sound information with an abnormal sound level of 86, the used paper tray information is “tray 1”, and for the abnormal sound information with an abnormal sound level of 75, the used paper tray information is “manual bypass tray”.

In the example of the abnormal sound information transmission history table in this case, it is seen that for the abnormal sound information transmitted to the management server 20 at the previous abnormal sound transmission time of “12/8/2022 00:00”, the used paper tray information is “tray 1”.

By storing such information, when the next transmission time of abnormal sound information arrives, abnormal sound information for which the used paper tray information is “tray 1” is not transmitted; instead, the abnormal sound information with the highest abnormal sound level among the abnormal sound information for which the used paper tray information is other than “tray 1” is selected and transmitted to the management server 20.

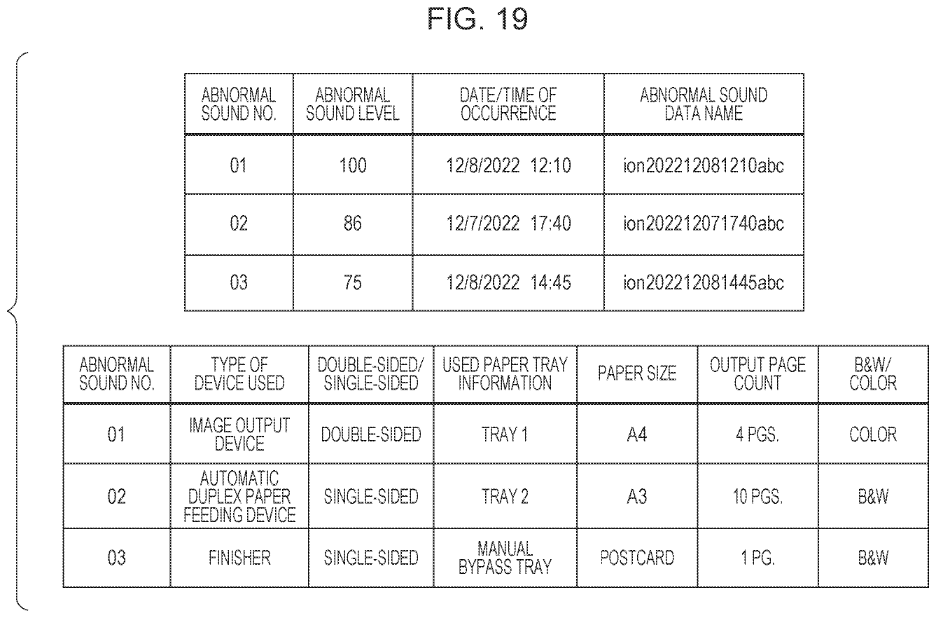

Note that various detailed device information other than the used paper tray information may be used as the characteristic information to be stored together with the abnormal sound information. An example of an abnormal sound information retention table in the case of retaining abnormal sound information with high abnormal sound levels together with detailed device information is illustrated in FIG. 19.

Referring to FIG. 19, it is seen that various information, such as the type of device used, information indicating double-sided/single-sided, used paper tray information, information indicating paper size, output page count information, and information indicating black and white/color, is stored as detailed device information stored together with the abnormal sound information.

An order of priority may be established, for example, to determine which of the detailed device information is to be used to select the abnormal sound information to be transmitted to the management server 20.

Note that when transmitting abnormal sound information to the management server 20, the control unit 37 may also include the number of pieces of abnormal sound information detected in a preset period, such as one day, for example.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The “system” in the exemplary embodiment refers to both a configuration formed by multiple devices and a configuration formed by a single device.

### EXEMPLARY MODIFICATION

The exemplary embodiment above is described using the case of collecting abnormal sound information in an image forming apparatus and transmitting the collected abnormal sound information to an external apparatus, but the present disclosure is not limited thereto, and the present disclosure may also be applied in a similar manner to an information processing apparatus other than an image forming apparatus, insofar as abnormal sounds occur in the apparatus when trouble occurs.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising a processor configured to:
collect sound information about sounds occurring in a monitored apparatus;
store collected sound information together with characteristic information about the collected sound information;
store, when collected sound information is transmitted to a set external apparatus, characteristic information pertaining to the sound information transmitted to the external apparatus; and
select and transmit to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.
   (((2)))

The information processing system according to (((1))), wherein the processor is configured to:
determine whether the collected sound information contains abnormal sounds by comparing the collected sound information to normal sound information; and
store only sound information determined to contain abnormal sounds, together with characteristic information about the collected sound information.
   (((3)))

The information processing system according to (((1))) or (((2))), wherein the characteristic information is information on a type of abnormal sounds contained in sound information.

(((4)))

The information processing system according to (((3))), wherein types of abnormal sounds contained in sound information include at least two from among sudden abnormal sounds, periodically occurring abnormal sounds, and continuous abnormal sounds.

(((5)))

The information processing system according to (((1))) or (((2))), wherein the characteristic information is information pertaining to details of operations by the monitored apparatus when sound information is collected.

(((6)))

The information processing system according to (((5))), wherein the information pertaining to details of operations by the monitored apparatus when sound information is collected includes at least two pieces of information from among information on a type of device that is operating when the sound information is collected, information on components used, and information pertaining to an operating state.

(((7)))

The information processing system according to any one of (((1))) to (((6))), wherein for sound information with the same characteristic information among collected sound information, the processor is configured to store only the sound information with a highest sound level.

(((8)))

A program causing a computer to execute a process comprising:
collecting sound information about sounds occurring in a monitored apparatus;
storing collected sound information together with characteristic information about the collected sound information;
storing, when collected sound information is transmitted to a set external apparatus, characteristic information pertaining to the sound information transmitted to the external apparatus; and
selecting and transmitting to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.

What is claimed is:

1. An information processing system comprising:
a processor configured to:
collect sound information about sounds occurring in a monitored apparatus;
store collected sound information together with characteristic information about the collected sound information;
store, when collected sound information is transmitted to a set external apparatus, characteristic information pertaining to the sound information transmitted to the external apparatus; and
select and transmit to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.

2. The information processing system according to claim 1, wherein the processor is configured to:
determine whether the collected sound information contains abnormal sounds by comparing the collected sound information to normal sound information; and
store only sound information determined to contain abnormal sounds, together with characteristic information about the collected sound information.

3. The information processing system according to claim 1, wherein the characteristic information is information on a type of abnormal sounds contained in sound information.

4. The information processing system according to claim 3, wherein types of abnormal sounds contained in sound information include at least two from among sudden abnormal sounds, periodically occurring abnormal sounds, and continuous abnormal sounds.

5. The information processing system according to claim 1, wherein the characteristic information is information pertaining to details of operations by the monitored apparatus when sound information is collected.

6. The information processing system according to claim 5, wherein the information pertaining to details of operations by the monitored apparatus when sound information is collected includes at least two pieces of information from among information on a type of device that is operating when the sound information is collected, information on components used, and information pertaining to an operating state.

7. The information processing system according to claim 1, wherein for sound information with the same characteristic information among collected sound information, the processor is configured to store only the sound information with a highest sound level.

8. An information processing method comprising:
collecting sound information about sounds occurring in a monitored apparatus;
storing collected sound information together with characteristic information about the collected sound information;
storing, when collected sound information is transmitted to a set external apparatus, characteristic information pertaining to the sound information transmitted to the external apparatus; and
selecting and transmitting to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.

9. A non-transitory computer readable medium storing a program causing a computer to execute a process comprising:
collecting sound information about sounds occurring in a monitored apparatus;
storing collected sound information together with characteristic information about the collected sound information;
storing, when collected sound information is transmitted to a set external apparatus, characteristic information pertaining to the sound information transmitted to the external apparatus; and
selecting and transmitting to the external apparatus, when a piece of sound information is selected from among stored sound information and is to be transmitted to the external apparatus, another piece of sound information, without selecting sound information having the same characteristic information as the characteristic information of the sound information that was transmitted to the external apparatus within a preset period in the past.
